(19) United States
(12) Patent Application Publication
(10) Pub. No.: US 2023/0313491 A1
(43) Pub. Date: Oct. 5, 2023

(54) Construction Machine

(71) Applicant: JDC Corporation, Tokyo (JP)

(72) Inventors: Masakazu Sekiguchi, Tokyo (JP); Hidetoshi Morimoto, Tokyo (JP); Hiroshi Obata, Tokyo (JP); Tsukasa Baba, Tokyo (JP)

(21) Appl. No.: 18/041,786

(22) PCT Filed: Dec. 15, 2020
(86) PCT No.: PCT/JP2020/046794

§ 371 Date: Feb. 15, 2023

Related U.S. Application Data
(60) Provisional application No. 63/076,960, filed on Sep. 11, 2020.

(51) Int. Cl. E02F 3/96; E02F 9/26; E02F 9/18; E02F 9/08; B64U 70/90

(52) U.S. Cl. CPC E02F 3/961; B64U 70/90; E02F 9/0858; E02F 9/18; E02F 9/26; B64U 2101/30

(57) ABSTRACT

A construction machine system that can shorten a work period is described. A construction machine system includes a main body that is revolvable by revolving of a revolving device, a first working device including a plurality of actuators and connected to the main body, and a second working device including a plurality of actuators and connected to the main body.

### TECHNICAL FIELD

The present invention relates to a construction machine such as a hydraulic excavator that performs excavation and loading work, and particularly relates to a construction machine for automatic operation.

### BACKGROUND

Conventionally, studies on automatic operation of a construction machine such as a hydraulic excavator has been promoted, and switching between manual operation and automatic operation is disclosed in JP Patent Publication No. 2016-89559 A.

### SUMMARY

However, there has been no proposal for shortening a work period in automatic operation of a construction machine.

Furthermore, to switch between manual operation and automatic operation, manned work has been assumed.

Therefore, an object of the present first invention is to provide a construction machine that can shorten a work period.

Furthermore, an object of the present second invention is to provide a construction machine that does not assume manned work.

A construction machine according to a first implementation of the invention includes: a main body unit revolvable by revolving of a revolving part; a first working device including a plurality of actuators and connected to the main body unit; and a second working device including a plurality of actuators and connected to the main body unit.

A construction machine according to a second implementation of the invention includes: a main body device that travels by a traveling device; a working device connected to the main body unit; a take-off and landing portion provided on the main body unit; and an unmanned flying object that takes off and lands at the take-off and landing portion.

According to the first implementation, it is possible to achieve a construction machine capable of shortening a work period because a first working device and a second working device are provided.

According to the second implementation, it is possible to provide a construction machine that does not assume manned work because an unmanned flying object assists the construction machine.

### BRIEF DESCRIPTION OF THE DRAWINGS

FIG. 1 is a schematic view of a construction machine system representing the present first embodiment.

FIG. 2 is a block diagram of the construction machine system of the present first embodiment.

FIG. 3A is a cross-sectional view of a main body device of the present first embodiment, and FIG. 3B is a view taken along a line A-A of FIG. 3A.

FIG. 4A is a schematic view of a hydraulic excavator as viewed from above when a first swing cylinder and a second swing cylinder are at initial positions, and FIG. 4B illustrates a state of the hydraulic excavator where a first working device is driven counterclockwise by the first swing cylinder and a second working device is driven clockwise by the second swing cylinder.

FIG. 5 is a flowchart executed by a central control device of the present first embodiment.

FIG. 6 is a flowchart related to excavation executed by a heavy machine control device of the present first embodiment.

FIG. 7 is a schematic view of a construction machine system representing the present second embodiment.

FIG. 8 is a block diagram of the construction machine system of the present second embodiment.

FIG. 9 is a flowchart executed by a central control device of the present second embodiment.

FIG. 10A is a view illustrating a state of a construction machine system of the present second embodiment where a drone performs surveying, FIG. 10B is a view illustrating a state where the drone captures an image of a working device performing excavation, and FIG. 10C is a view illustrating a state where the drone captures an image of a first bucket performing excavation.

### DETAILED DESCRIPTION

Hereinafter, a construction machine system 1 of a first embodiment of the present invention will be described in detail with reference to the accompanying drawings. Note that the present invention is not limited by the embodiment described below. In the present embodiment, the description will be continued by using a hydraulic excavator 10 as an example of a construction machine.

### First Embodiment

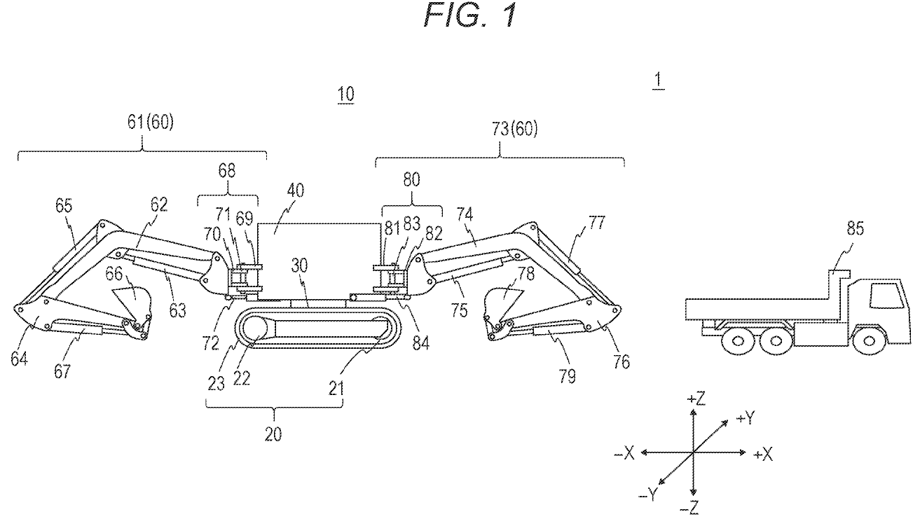

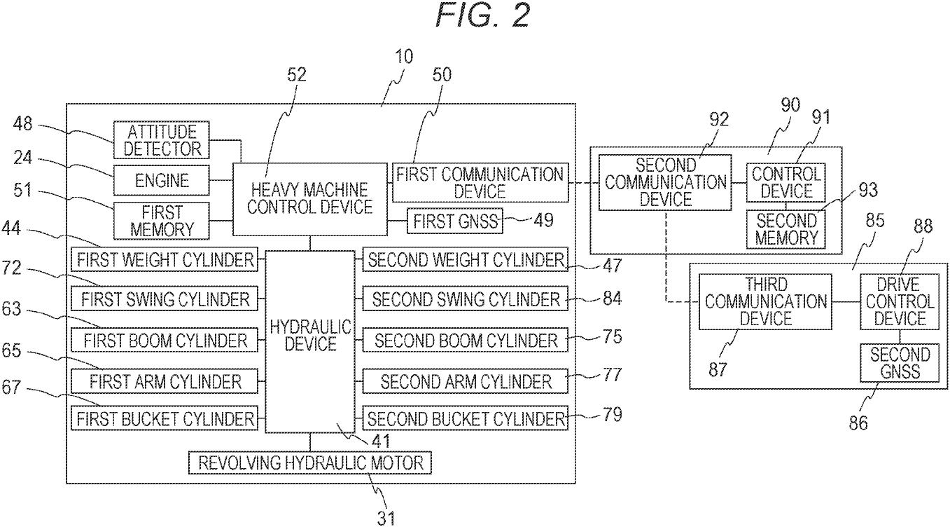

FIG. 1 is a schematic view illustrating the construction machine system 1 representing the present embodiment. FIG. 2 is a block diagram of the construction machine system 1 of the present embodiment. Hereinafter, a configuration of the construction machine system 1 will be described with reference to FIGS. 1 and 2. The construction machine system 1 of the present embodiment includes the hydraulic excavator 10, a dump truck 85, and a central control device 90.

Note that, as is clear from FIG. 1, the hydraulic excavator 10 of the present embodiment is an automatic operation type without a driver’s seat, and includes a plurality of working devices 60 to be described later. Note that the hydraulic excavator 10 may be traveled by automatic operation at a construction site and may be loaded on a trailer for transportation on a public road.

### Hydraulic Excavator 10

The hydraulic excavator 10 of the present embodiment includes a traveling device 20, a revolving device 30, a main body device 40, and the working devices 60.

The traveling device 20 includes a pair of crawler belts 23 wound around idler wheels 21 and drive wheels 22, and the pair of crawler belts 23 is driven by the drive wheels 22 to cause the hydraulic excavator 10 to travel. Note that an engine 24 of an internal combustion engine constituting the traveling device 20 can be disposed in the main body device 40. Furthermore, the traveling device 20 may be driven by a battery and a motor instead of the engine 24 of the internal combustion engine, or may be a hybrid type in which the engine 24 of the internal combustion engine and a motor are combined. Note that the traveling device 20 may be a tire type wheel system.

The revolving device 30 is disposed in the traveling device 20 and the main body device 40. The revolving device 30 includes a bearing (not illustrated) and a revolving hydraulic motor 31, and revolves the main body device 40 and the working device 60.

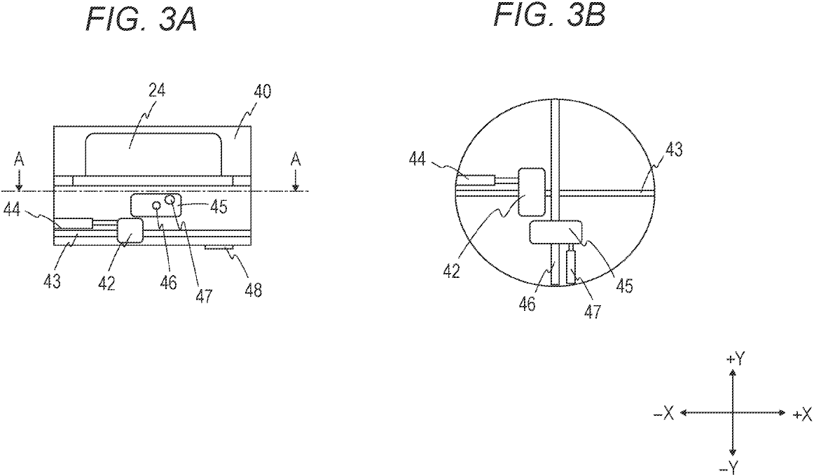

FIG. 3A is a cross-sectional view of the main body device 40 of the present first embodiment, and FIG. 3B is a view taken along a line A-A of FIG. 3A. FIGS. 3A and 3B illustrate a first mass body 42, a first guide shaft 43, a first weight cylinder 44, a second mass body 45, a second guide shaft 46, a second weight cylinder 47, and an attitude detector 48.

The main body device 40 has the upper surface having a flat shape and side surfaces connected to the working devices 60. Inside the main body device 40, the engine 24 described above, a hydraulic device 41, the first mass body 42, the first guide shaft 43 that guides the first mass body 42, the first weight cylinder 44 that moves the first mass body 42 along the first guide shaft 43, the second mass body 45, the second guide shaft 46 that guides the second mass body 45, the second weight cylinder 47 that moves the second mass body 45 along the second guide shaft 46, and the attitude detector 48 are provided. The hydraulic device 41 includes a hydraulic pump connected to the engine 24, a hydraulic control valve, and the like, and drives a plurality of cylinders as actuators provided in the working devices 60. Some of the plurality of cylinders include the first weight cylinder 44 and the second weight cylinder 47.

The first mass body 42 and the second mass body 45 correct an unbalanced load acting on the hydraulic excavator 10 by driving the working devices 60, and function as counter masses. In a case where a first bucket 66 to be described later performs excavation, an unbalanced load in a -X direction acts on the hydraulic excavator 10. Thus, by moving the first mass body 42 in a +X direction, the unbalanced load acting on the hydraulic excavator 10 can be corrected.

Furthermore, in a case where the first bucket 66 that has performed excavation revolves along a clockwise direction by the revolving device 30, an unbalanced load in a +Y direction acts on the hydraulic excavator 10. Thus, by moving the first mass body 42 in a -Y direction, the unbalanced load acting on the hydraulic excavator 10 can be corrected.

As compared with a case where the first mass body 42 and the second mass body 45 are not driven, weights of the first mass body 42 and the second mass body 45 can be reduced by driving the first mass body 42 and the second mass body 45.

The first guide shaft 43 is provided along an X direction, and guides movement of the first mass body 42. As the first weight cylinder 44, a hydraulic cylinder is used in the present embodiment, and the first weight cylinder 44 moves the first mass body 42 by hydraulic pressure.

The second guide shaft 46 is provided along a Y direction, and guides movement of the second mass body 45. As the second weight cylinder 47, a hydraulic cylinder is used in the present embodiment, and the second weight cylinder 47 moves the second mass body 45 by hydraulic pressure.

Note that the movement of the first mass body 42 and the second mass body 45 may be performed by linear motors instead of the hydraulic cylinders. In this case, when moving magnet type linear motors in which stators are coils and magnets are provided on sides of the first mass body 42 and the second mass body 45 are used, the unbalanced load acting on the hydraulic excavator 10 can be corrected by also using weights of the magnets.

As the first mass body 42 and the second mass body 45, a metal block may be used, the engine 24 may be used, or the battery described above may be used. By diverting parts such as the engine 24 and the battery, the number of parts can be reduced.

Note that a configuration in which one of the first mass body 42 and the second mass body 45 is omitted may be adopted.

The attitude detector 48 is a sensor that is attached to the main body device 40 and detects an attitude of the main body device 40. As the attitude detector 48, an inclinometer, a level, or the like can be used. The movement of the first mass body 42 and the second mass body 45 can be performed according to the attitude of the main body device 40 detected by the attitude detector 48. Note that the attitude detector 48 illustrated in FIGS. 3 is provided in a lower periphery of the main body device 40. This is because a mechanical part and an electronic part for transmitting output of the engine 24 to the traveling device 20 are provided in a lower central portion of the main body device 40.

Furthermore, in the present embodiment, the main body device 40 includes a first global navigation satellite system (GNSS) 49 that is a global positioning system, a first communication device 50, a first memory 51, and a heavy machine control device 52 that controls the entire hydraulic excavator 10. The first GNSS 49 measures a position of the hydraulic excavator 10 by using an artificial satellite.

The first communication device 50 is a wireless communication unit that accesses the central control device 90 or a wide area network such as the Internet. In the present embodiment, the first communication device 50 transmits the position of the hydraulic excavator 10 detected by the first GNSS 49 to the central control device 90 via a second communication device 92, and receives data related to automatic operation of the main body device 40 from the central control device 90 via the second communication device 92.

The first memory 51 is a nonvolatile memory (for example, a flash memory), and stores various types of data and programs for driving the hydraulic excavator 10 and various types of data and programs for automatically operating the hydraulic excavator 10.

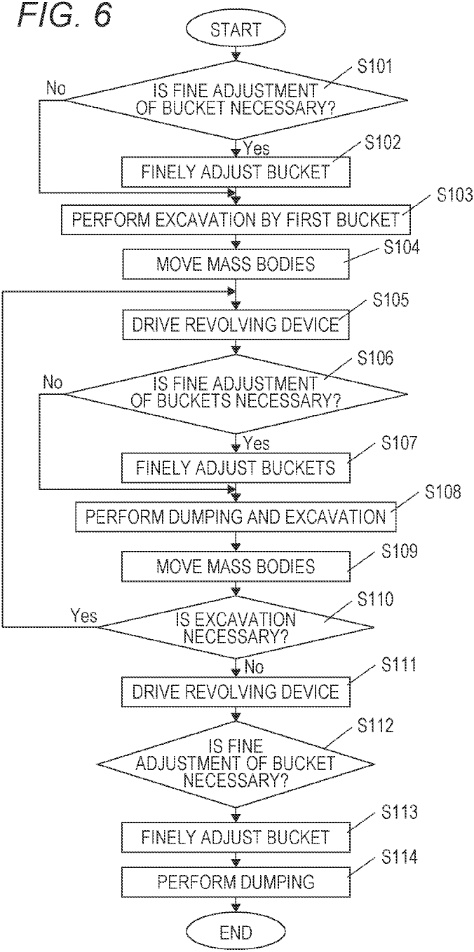

The heavy machine control device 52 is a control device that includes a CPU and controls the entire hydraulic excavator 10. The control of the hydraulic excavator 10 by the heavy machine control device 52 will be described later with reference to FIG. 6.

The working devices 60 include a first working device 61 and a second working device 73. As illustrated in FIG. 1, the first working device 61 and the second working device 73 are provided to be shifted by 180 degrees along the X direction, but may be provided to be shifted by 90 degrees. Furthermore, the number of the working devices 60 is not limited to two, and may be three or more.

Because the first working device 61 and the second working device 73 have the same configuration in the present embodiment, the description will be continued for the configuration of the first working device 61. The first working device 61 includes a first boom 62, a first boom cylinder 63, a first arm 64, a first arm cylinder 65, the first bucket 66, a first bucket cylinder 67, and a first swing unit 68.

The first boom 62 is a chevron-shaped part connected to the main body device 40 via the first swing unit 68, and is rotated by the first boom cylinder 63.

The first arm 64 is connected to a distal end of the first boom 62, and is rotated by the first arm cylinder 65.

The first bucket 66 is connected to a distal end of the first arm 64, and is rotated by the first bucket cylinder 67. Note that, instead of the first bucket 66, a breaker can be attached to the distal end of the first arm 64.

In the present embodiment, the first boom cylinder 63, the first arm cylinder 65, and the first bucket cylinder 67 are hydraulic cylinders, and extend and contract by hydraulic pressure. Furthermore, the extending and contracting operation of the first boom cylinder 63, the first arm cylinder 65 and the first bucket cylinder 67 is performed by the hydraulic device 41.

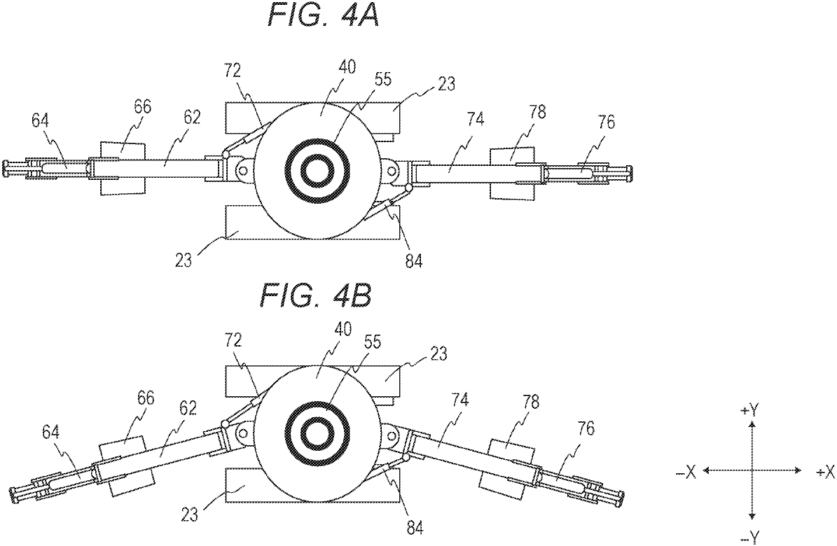

FIGS. 4A and 4B are schematic views of the hydraulic excavator 10 as viewed from above, in which FIG. 4A is a schematic view when a first swing cylinder 72 and a second swing cylinder 84 are at initial positions, and FIG. 4B illustrates a state where the first working device 61 is driven counterclockwise by the first swing cylinder 72 and the second working device 73 is driven clockwise by the second swing cylinder 84.

In the first swing unit 68, first main body side members 69 and first boom side members 70 are pivotally supported by a first shaft support member 71, and the first swing unit 68 rotates the first working device 61 around a Z axis by the first swing cylinder 72 connected to the first boom 62. In the present embodiment, an angle at which the first swing unit 68 rotates the first working device 61 is about 5 degrees to 15 degrees. Furthermore, the first swing cylinder 72 is a hydraulic cylinder, and extending and contracting operation thereof is performed by the hydraulic device 41. Note that, as illustrated in FIGS. 4A and 4B, a visual recognition mark 55 visually recognizable from the sky may be provided on the upper surface of the main body device 40. Note that a shape of the visual recognition mark is not limited to a circular shape, and may be a rectangular shape, an elliptical shape, or a triangular shape, and may be a double mark, or a single mark.

### Dump Truck 85

Although a well-known dump truck 85 can be used as the dump truck 85, the dump truck 85 includes a second GNSS 86, a third communication device 87, and a drive control device 88 that controls the entire dump truck 85 because automatic operation is performed under the control of the central control device 90 in the present embodiment. The second GNSS 86 measures a position of the dump truck 85. Note that the dump truck 85 may be traveled by automatic operation at a construction site and may be traveled by operation by a person on a public road.

The third communication device 87 communicates the position of the dump truck 85 detected by the second GNSS 86 to the central control device 90 via the second communication device 92. Furthermore, the third communication device 87 receives data related to automatic operation from the central control device 90. Note that a wireless communication unit may be used as the third communication device 87.

### Central Control Device 90

The central control device 90 is a control device that controls the entire construction machine system 1. The central control device 90 includes a control device 91, the second communication device 92, and a second memory 93. The control device 91 includes a CPU and controls the hydraulic excavator 10 and the dump truck 85. The second communication device 92 is a wireless communication unit, and communicates with the first communication device 50 and the third communication device 87. Note that the second communication device 92 can also access a wide area network such as the Internet. The second memory 93 is a nonvolatile memory (for example, a flash memory), and stores various types of data and programs for controlling the hydraulic excavator 10 and the dump truck 85.

### Description of Flowchart

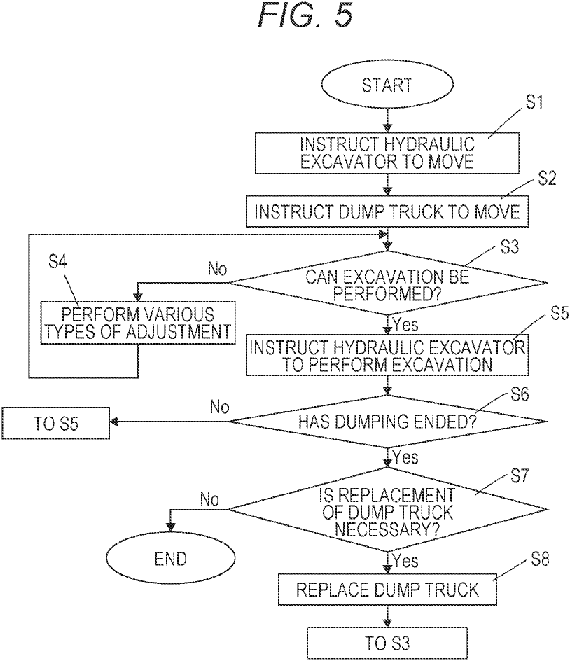

FIG. 5 is a flowchart executed by the central control device 90 of the present embodiment, and FIG. 6 is a flowchart related to excavation executed by the heavy machine control device 52 of the present first embodiment. Hereinafter, the description will be continued for the flowcharts of FIGS. 5 and 6 in sequence.

The central control device 90 instructs the hydraulic excavator 10 at a construction site to move to an excavation place (Step S1). The central control device 90 establishes communication between the first communication device 50 and the second communication device 92, and instructs the hydraulic excavator 10 to move toward the excavation place.

The central control device 90 instructs the dump truck 85 at the construction site to move to a dumping place near the excavation place (Step S2). The central control device 90 establishes communication between the second communication device 92 and the third communication device 87, and instructs the dump truck 85 to move toward the dumping place.

The central control device 90 determines whether or not the hydraulic excavator 10 can perform excavation (Step S3). The central control device 90 proceeds to Step S5 when the hydraulic excavator 10 arrives at the excavation place and can perform excavation and the dump truck 85 arrives at the dumping place, and proceeds to Step S4 otherwise. Here, the description will be continued assuming that the central control device 90 proceeds to Step S4. Note that the central control device 90 may determine the process by the hydraulic excavator 10 being near the excavation place without considering the dump truck 85 as the determination in Step S3.

The central control device 90 recognizes that it is necessary to adjust relative positions of the hydraulic excavator 10 and the dump truck 85 by the communication between the first communication device 50 and the second communication device 92 and the communication between the second communication device 92 and the third communication device 87, performs various types of adjustment such as issuing an instruction to adjust the position of the dump truck 85, and proceeds to Step S3 again (Step S4).

The central control device 90 determines whether or not the hydraulic excavator 10 can perform excavation (Step S3), and by the communication between the first communication device 50 and the second communication device 92 and the communication between the second communication device 92 and the third communication device 87, assumes that the relative positions of the hydraulic excavator 10 and the dump truck 85 have entered a predetermined range, and proceeds to Step S5. Here, the predetermined range means that a bucket (a second bucket 78 in FIG. 1) positioned near the dump truck 85 is in a range in which dumping can be performed onto a loading platform of the dump truck 85.

The central control device 90 instructs the hydraulic excavator 10 to perform excavation (Step S5). Excavation by the hydraulic excavator 10 will be described later with reference to the flowchart of FIG. 6.

The central control device 90 determines whether or not dumping onto the dump truck 85 by the hydraulic excavator 10 has ended (Step S6). The central control device 90 repeats Steps S5 and S6 until the loading platform of the dump truck 85 is almost full of excavation objects.

When the loading platform of the dump truck 85 is almost full of the excavation objects, the central control device 90 determines whether or not to replace the dump truck 85 (Step S7). When work for the day has not been ended, the central control device 90 proceeds to Step S8, and when the work for the day has been ended, the central control device 90 moves the dump truck 85 from the dumping place, and ends this flowchart. Here, the description will be continued assuming that the central control device 90 determines that the replacement of the dump truck 85 is necessary.

In order to replace the dump truck 85, the central control device 90 moves the dump truck 85 at the dumping place from the dumping place, and moves a dump truck 85 having an empty loading platform (not illustrated) to the dumping place. Note that, in order to shorten a replacement time of the dump truck 85, the central control device 90 may cause the dump truck 85 having the empty loading platform (not illustrated) to stand by near the dumping place in advance.

When the replacement of the dump truck 85 is ended, the central control device 90 repeats Steps S3 to S8 in order to perform the next excavation. Then, when a scheduled excavation amount is reached, the central control device 90 determines No in Step S7, and ends this flowchart.

Next, the description will be continued for excavation executed by the heavy machine control device 52 with reference to the flowchart of FIG. 6. Note that the flowchart of FIG. 6 is started when the first communication device 50 receives the excavation instruction from the central control device 90 in Step S5 of the flowchart of FIG. 5, as described above.

The heavy machine control device 52 determines whether or not fine adjustment of a position of the first bucket 66 is necessary prior to the start of the excavation (Step S101). The heavy machine control device 52 proceeds to Step S102 when the fine adjustment of the position of the bucket is necessary, and proceeds to Step S103 when the fine adjustment of the position of the bucket is unnecessary. Here, it is assumed that the heavy machine control device 52 proceeds to Step S102 assuming that the fine adjustment of the position of the bucket is necessary.

The heavy machine control device 52 drives the first swing cylinder 72 to finely adjust the position of the first bucket 66 (Step S102).

Next, the heavy machine control device 52 performs excavation by the first bucket 66 (Step S103). The heavy machine control device 52 drives and controls the first boom cylinder 63, the first arm cylinder 65, and the first bucket cylinder 67 by the hydraulic device 41, to perform the excavation by the first bucket 66.

In parallel with the excavation control in Step S103, the heavy machine control device 52 performs unbalanced load correction of the hydraulic excavator 10 by movement of the first mass body 42 and the second mass body 45 (Step S104). As described above, when the first bucket 66 performs excavation, the unbalanced load in the -X direction acts on the hydraulic excavator 10. Thus, by moving the first mass body 42 in the +X direction, the heavy machine control device 52 corrects the unbalanced load acting on the hydraulic excavator 10. In this case, the heavy machine control device 52 performs feedforward control to calculate the unbalanced load acting on the hydraulic excavator 10 from driving amounts of the first boom cylinder 63, the first arm cylinder 65, and the first bucket cylinder 67 and move the first mass body 42 and the second mass body 45 together with the start of the excavation in Step S103. Furthermore, the heavy machine control device 52 performs feedback control to control the movement of the first mass body 42 and the second mass body 45 on the basis of a detection result of the attitude detector 48. Note that gravimeters may be provided in the first bucket 66 and the second bucket 78, and a weight of excavation objects may be measured by the gravimeter and used for the feedforward control and the feedback control described above.

Because the heavy machine control device 52 performs the feedforward control to perform the unbalanced load correction almost at the same time as the unbalanced load acts on the hydraulic excavator 10, it is possible to quickly perform the unbalanced load correction acting on the hydraulic excavator 10 before the large, unbalanced load acts on the hydraulic excavator 10. Furthermore, because the heavy machine control device 52 performs the feedback control based on the detection result of the attitude detector 48, it is possible to accurately correct the unbalanced load acting on the hydraulic excavator 10. Note that the heavy machine control device 52 may perform the unbalanced load correction by driving the second bucket 78 when the first bucket 66 performs the excavation, or may use the first mass body 42, the second mass body 45, and the second bucket 78 in combination. In this case, it is preferable to perform the feedback control in consideration of the drive of the second bucket 78 when the feedforward control described above is performed.

When the excavation in Step S103 is ended, the heavy machine control device 52 revolves the main body device 40 and the working device 60 180 degrees by the revolving device 30 (Step S105). By the revolving of the main body device 40 and the working device 60 by the revolving device 30, the first bucket 66 is positioned near the dump truck 85 and the second bucket 78 is positioned near the excavation place. Also in this case, in a case where the first bucket 66 revolves along the clockwise direction by the revolving device 30, the unbalanced load in the +Y direction acts on the hydraulic excavator 10. Thus, it is preferable to move the first mass body 42 so as to correct the unbalanced load acting on the hydraulic excavator 10.

The heavy machine control device 52 determines whether or not fine adjustment of the positions of the first bucket 66 and the second bucket 78 is necessary (Step S106). The heavy machine control device 52 proceeds to Step S107 when the fine adjustment of the position of at least one of the first bucket 66 and the second bucket 78 is necessary, and proceeds to Step S108 when the fine adjustment of the position of the bucket is unnecessary. Here, it is assumed that the heavy machine control device 52 proceeds to Step S107 assuming that the fine adjustment of the position of the bucket is necessary.

The heavy machine control device 52 drives the first swing cylinder 72 and the second swing cylinder 84 to finely adjust the positions of the first bucket 66 and the second bucket 78 (Step S107). Specifically, the heavy machine control device 52 drives the first swing cylinder 72 so that the first bucket 66 can perform dumping onto the loading platform of the dump truck 85. Furthermore, the heavy machine control device 52 drives the second swing cylinder 84 so that the second bucket 78 is positioned at the excavation place.

The heavy machine control device 52 dumps excavation objects excavated by the first bucket 66 onto the loading platform of the dump truck 85, and performs excavation by the second bucket 78 (Step S108). The heavy machine control device 52 drives and controls the first boom cylinder 63, the first arm cylinder 65, and the first bucket cylinder 67 by the hydraulic device 41 to perform the dumping by the first bucket 66. Furthermore, the heavy machine control device 52 drives and controls a second boom cylinder 75, a second arm cylinder 77, and a second bucket cylinder 79 by the hydraulic device 41 to perform the excavation by the second bucket 78.

In parallel with the excavation control in Step S108, the heavy machine control device 52 performs unbalanced load correction of the hydraulic excavator 10 by movement of the first mass body 42 and the second mass body 45 (Step S109). The heavy machine control device 52 preferably uses the feedforward control and the feedback control in combination also for the unbalanced load correction in Step S109.

The heavy machine control device 52 determines whether or not further excavation is necessary (Step S110). The heavy machine control device 52 proceeds to Step S105 when excavation scheduled on the day has not been ended, and proceeds to Step S111 when the excavation scheduled on the day has been ended.

The heavy machine control device 52 revolves the main body device 40 and the working device 60 180 degrees by the revolving device 30 (Step S111). In a case where the main body device 40 and the working device 60 are revolved along the clockwise direction in Step S105, the heavy machine control device 52 revolves the main body device 40 and the working device 60 along a counterclockwise direction. Conversely, in a case where the main body device 40 and the working device 60 are revolved along the counterclockwise direction in Step S105, the heavy machine control device 52 revolves the main body device 40 and the working device 60 along the clockwise direction. In this way, it is sufficient to avoid interference of the working device 60 with another device in the revolving range of 180 degrees, and as compared with a case of avoiding interference of the working device 60 with another device in a revolving range of 360 degrees, safety confirmation becomes easier, and the construction site can be used effectively.

Because the heavy machine control device 52 does not perform excavation, the heavy machine control device 52 determines whether or not to adjust the position of the bucket near the dump truck 85 (Step S112). Here, the description will be continued assuming that the second bucket 78 is near the dump truck 85 and fine adjustment is necessary.

The heavy machine control device 52 drives the second swing cylinder 84 to finely adjust the position of the second bucket 78 (Step S113). Specifically, the heavy machine control device 52 drives the second swing cylinder 84 so that the second bucket 78 can perform dumping onto the loading platform of the dump truck 85 (S114).

Next, the heavy machine control device 52 dumps excavation objects excavated by the second bucket 78 onto the loading platform of the dump truck 85. Note that, because the excavation by the first bucket 66 is not performed here, a large, unbalanced load does not act on the hydraulic excavator 10. Thus, the unbalanced load correction by the first mass body 42 and the second mass body 45 may be performed or may be omitted.

As described above in detail, because the two working devices 60 are provided in the present embodiment, it is possible to perform excavation and dumping almost at the same time, and thus, it is possible to achieve the hydraulic excavator 10 with good workability. Note that, in the present embodiment described above, image capturing devices may be provided in the first bucket 66, the second bucket 78, and the main body device 40 to capture images of excavation situations of the first bucket 66 and the second bucket 78.

### Second Embodiment

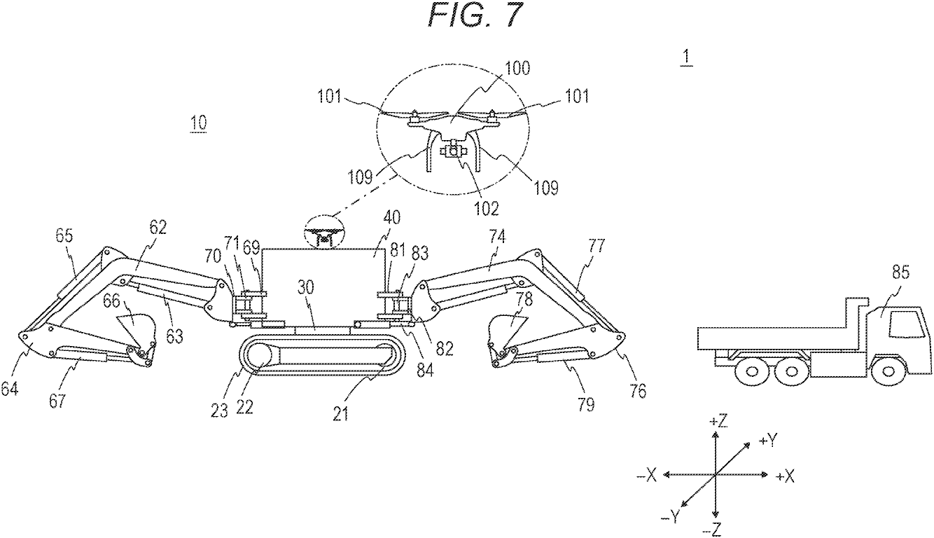

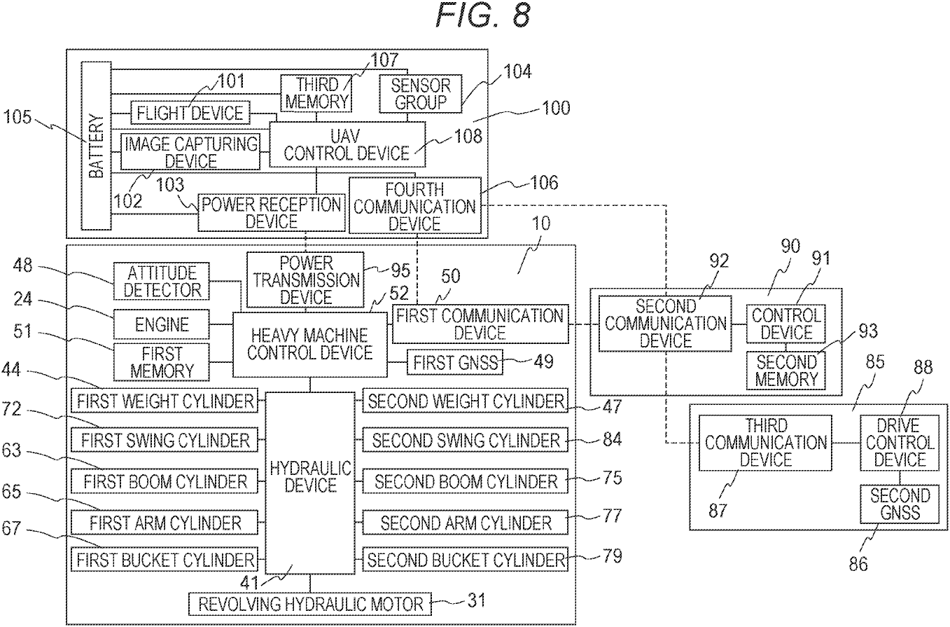

Hereinafter, a second embodiment will be described with reference to FIGS. 7 and 8, but the same configurations as those of the first embodiment are denoted by the same reference signs, and description thereof will be omitted or simplified.

FIG. 7 is a schematic view of a construction machine system 1 representing the present second embodiment, and FIG. 8 is a block diagram of the construction machine system 1 of the present second embodiment. The present embodiment is different from the first embodiment in that an unmanned aerial vehicle (UAV), hereinafter referred to as a drone 100, is provided. Furthermore, in a hydraulic excavator 10 of the present embodiment, an upper surface of a main body device 40 is a take-off and landing portion at which the drone 100 can take off and land, and a power transmission device 95 capable of transmitting power to the drone 100 is provided in the take-off and landing portion. Furthermore, a mark serving as a guide when the drone 100 lands is formed on the take-off and landing portion.

The power transmission device 95 supplies power to a power reception device 103 to be described later on a side of the drone 100, and adopts wireless power supply in the present embodiment. The wireless power supply supplies power to the power reception device 103 in a non-contact manner, and a magnetic field resonance system, an electromagnetic induction system, and the like are known. The power transmission device 95 of the present embodiment includes a power supply, a control circuit, and a power transmission coil. The power transmission coil is preferably provided in the take-off and landing portion.

Note that a contact-type power supply system may be adopted instead of the wireless power supply. In this case, a metal contact may be provided on each of the power transmission device 95 and the power reception device 103, and the contacts may be mechanically connected to each other for power supply. For example, a contact having a recess shape may be provided on the take-off and landing portion, and a contact having a projection shape may be provided on the side of the drone 100. One contact having the recess shape and one contact having the projection shape may be provided, or a plurality of the contacts having the recess shape and a plurality of the contacts having the projection shape may be provided.

In a case where the hydraulic excavator 10 moves in a construction site with unevenness in a state where the drone 100 lands on the take-off and landing portion, it is desirable to mechanically engage or electromagnetically connect the drone 100 and the take-off and landing portion so that the drone 100 does not move away from the take-off and landing portion. In the present embodiment, a lock mechanism that applies a mechanical lock when the drone 100 lands on the take-off and landing portion is adopted.

The drone 100 of the present embodiment includes flight devices 101, an image capturing device 102, the power reception device 103, a sensor group 104, a battery 105, a fourth communication device 106, a third memory 107, and a UAV control device 108.

The flight device 101 includes a motor (not illustrated) and a plurality of propellers, and floats the drone 100 in the air and generates thrust to move the drone 100 in the air.

The image capturing device 102 is a digital camera that includes a lens, an imaging element, an image processing engine, and the like, and captures a moving image and a still image. In the present embodiment, the image capturing device 102 performs surveying and captures an image of an excavated portion. In an enlarged view surrounded by an alternate long and short dash line in FIG. 7, the lens of the image capturing device 102 is attached to a side surface (front surface) of the drone 100, but the lens of the image capturing device 102 may be attached to a lower surface of the drone 100, or a plurality of lenses may be provided in the drone 100. Furthermore, a moving mechanism that moves the lens attached to the side surface toward the lower surface may be provided.

Note that an omnidirectional camera (360 degree camera) may be used as the image capturing device 102, or a three-dimensional scanner may be used instead of the image capturing device 102.

The power reception device 103 includes power reception coils, charging circuits, and the like provided in leg portions 109 of the drone 100, and charges the battery 105 with power from the power transmission device 95.

The battery 105 is a secondary battery connected to the power reception device 103, and a lithium ion secondary battery, a lithium polymer secondary battery, or the like can be used as the battery 105, but the battery 105 is not limited thereto. The battery 105 can supply power (e.g., electric energy) to the flight devices 101, the image capturing device 102, the fourth communication device 106, the third memory 107, and the UAV control device 108.

The sensor group 104 is a GNSS, an infrared sensor for avoiding collision between the drone 100 and another device (for example, the working device 60), a gyro sensor that detects an attitude of the drone 100, an acceleration sensor that detects acceleration acting on the drone 100, and the like.

The fourth communication device 106 includes a wireless communication unit, and communicates with a first communication device 50 and a second communication device 92. In the present embodiment, the fourth communication device 106 transmits image data captured by the image capturing device 102 and a detection result detected by the sensor group 104 to the second communication device 92, and transmits a flight command from the second communication device 92 to the UAV control device 108.

The third memory 107 is a nonvolatile memory (for example, a flash memory), and stores various types of data and programs for flying the drone 100, and stores image data captured by the image capturing device 102, a detection result detected by the sensor group 104, and the like.

The UAV control device 108 includes a CPU, an attitude control circuit, a flight control circuit, and the like, and controls the entire drone 100. Furthermore, the UAV control device 108 determines timing of charging from a remaining amount of the battery 105, and controls an image capturing position, an angle of view, a frame rate, and the like of the image capturing device 102.

### Description of Flowchart

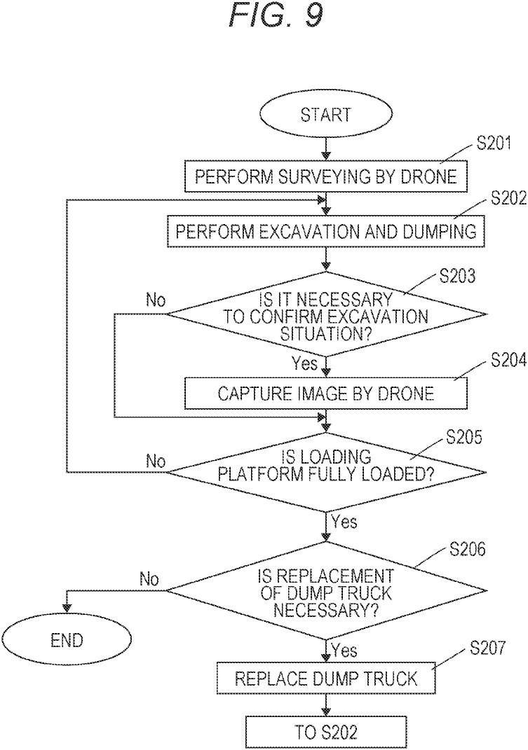

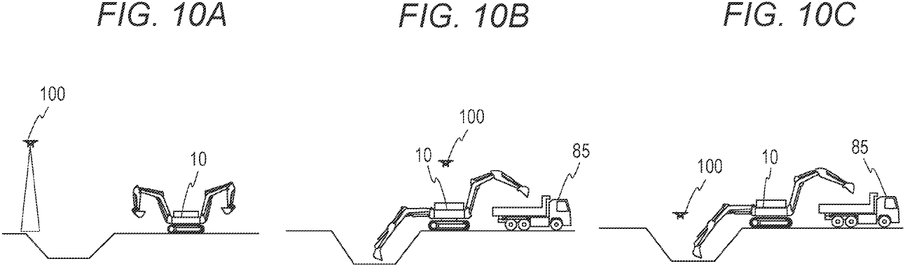

FIG. 9 is a flowchart executed by a central control device 90 of the present second embodiment, and FIGS. 10 is a view illustrating a state of the construction machine system 1 of the present second embodiment.

Hereinafter, the description will be continued mainly on control of the drone 100 with reference to FIGS. 9 and 10. Note that it is assumed that the flowchart of FIG. 9 is executed when the hydraulic excavator 10 arrives near an excavation place.

The central control device 90 establishes communication between the second communication device 92 and the fourth communication device 106, and instructs the UAV control device 108 to perform surveying by the drone 100 (Step S201). In response to the survey instruction from the central control device 90, the UAV control device 108 drives the flight devices 101 to raise the drone 100 and starts surveying by the image capturing device 102. FIG. 10A is a view illustrating a state where the drone 100 performs surveying, and in the present embodiment, the UAV control device 108 raises the drone 100 to a height of about 6 m to 12 m above the ground and starts surveying by the image capturing device 102.

The image capturing device 102 moves the lens attached to the side surface toward the lower surface by the moving mechanism described above, and starts capturing an image of the excavation place. Image data captured by the image capturing device 102 is stored in the third memory 107, and then transmitted from the fourth communication device 106 to the second communication device 92. The central control device 90 ends Step S201 when the surveying is ended by the image data transmitted from the drone 100. Note that a human may determine whether or not the surveying is sufficient.

The central control device 90 establishes communication between the first communication device 50 and the second communication device 92, and instructs a heavy machine control device 52 to perform excavation and dumping (Step S202). As described in the first embodiment, the central control device 90 performs excavation and dumping by using a first bucket 66 and a second bucket 78. FIG. 10B is a view illustrating a state where the drone 100 captures an image of the working device 60 performing excavation, and in the present embodiment, it is assumed that the image capturing device 102 captures the image of the state of excavation from the sky. In this case, by performing the image capturing at a height or altitude of about 3 m to 6 m above the ground, which is lower than the altitude where the surveying is performed, the image of the state of the excavation can be captured. Furthermore, the image capturing of the state of the excavation may be continuously performed, or may be performed at regular intervals in order to enable the battery 105.

The central control device 90 determines whether or not it is necessary to confirm an excavation situation on the basis of the image data from the image capturing device 102 (Step S203). Here, it is assumed that the central control device 90 proceeds to Step S204 assuming that it is necessary to confirm the state of the first bucket 66.

The central control device 90 instructs the UAV control device 108 to capture an image of the first bucket 66 (Step S204). The UAV control device 108 lowers the drone 100 closer to the first bucket 66 by the flight devices 101, and instructs image capturing by the image capturing device 102. FIG. 10C is a view illustrating a state where the drone 100 captures an image of the first bucket 66 performing excavation. In this case, the UAV control device 108 can recognize the first bucket 66 by the infrared sensor of the sensor group 104, and can move the drone 100 closer to the first bucket 66 while avoiding collision between the first bucket 66 and the drone 100. Note that the central control device 90 may stop movement of at least one of the hydraulic excavator 10 and the dump truck 85 when the hydraulic excavator 10 and the dump truck 85 approach each other to a predetermined distance (for example, several tens of cm to 1 m) on the basis of the image capturing of the image capturing device 102. This can prevent the hydraulic excavator 10 and the dump truck 85 from coming into contact with each other or colliding with each other.

Next, the central control device 90 determines whether or not a loading platform of the dump truck 85 is fully loaded (Step S205). The central control device 90 instructs the UAV control device 108 to capture an image of the loading platform of the dump truck 85. The UAV control device 108 moves the drone 100 closer to the loading platform of the dump truck 85, and instructs image capturing by the image capturing device 102. Also in this case, the UAV control device 108 can recognize the loading platform of the dump truck 85 by the infrared sensor of the sensor group 104, and can move the drone 100 closer to the loading platform of the dump truck 85 while avoiding collision between the dump truck 85 and the drone 100.

The central control device 90 returns to Step S202 when the loading platform of the dump truck 85 is not fully loaded, and proceeds to Step S206 when the loading platform of the dump truck 85 is fully loaded. Here, it is assumed that the central control device 90 proceeds to Step S206 assuming that the loading platform of the dump truck 85 is fully loaded.

The central control device 90 determines whether or not replacement of the dump truck 85 is necessary (Step S206). When predetermined excavation is ended, the central control device 90 determines that the replacement of the dump truck 85 is not necessary, moves the fully loaded dump truck 85 from a dumping place, and ends this flowchart. On the other hand, when the predetermined excavation has not been ended and it is determined that the replacement of the dump truck 85 is necessary, the central control device 90 proceeds to Step S207.

The central control device 90 replaces the dump truck 85 (Step S207), and repeats the steps after Step S202 until the predetermined excavation is ended.

Note that, in the present embodiment, the drone 100 is controlled by the central control device 90, but the drone 100 may be controlled by the heavy machine control device 52.

As described above, according to the present embodiment, because the drone 100 assists the construction machine system 1, automated construction work can be efficiently implemented.

The embodiment described above is merely an example for describing the present invention, and various changes can be made without departing from the gist of the present invention. For example, when an infrared camera is used as the image capturing device 102, a series of work such as excavation and dumping can be performed even at night, and a work period can be shortened. Instead of the first bucket, a breaker, a fork, a ripper, or a lifter may be attached to the first arm 64. Furthermore, the first embodiment and the second embodiment may be appropriately combined. Furthermore, a landing position may be recognized by visually recognizing the visual recognition mark 55 of FIGS. 4 by the image capturing device 102 when the drone 100 lands on the take-off and landing portion. Furthermore, when the power transmission coil or the contact of the power transmission device 95 (e.g., a part of the power supply unit) is provided in the visual recognition mark 55, the battery 105 can be charged via the power reception device 103 promptly after the drone 100 lands on the take-off and landing portion.

The following is a list of reference signs used in the drawing figures and in this specification.

| | |
|---|---|
| 1 | Construction machine system |
| 10 | Hydraulic excavator |
| 20 | Traveling device |
| 30 | Revolving device |
| 40 | Main body device |
| 40, 41 | Hydraulic device |
| 42 | First mass body |
| 45 | Second mass body |
| 48 | Attitude detector |
| 52 | Heavy machine control device |
| 60 | Working device |
| 61 | First Working Device |
| 73 | Second working device |
| 85 | Dump truck |
| 90 | Central control device |
| 95 | Power transmission device |
| 100 | Drone |
| 102 | Image capturing device |
| 103 | Power reception device |
| 104 | Sensor group |
| 105 | Battery |
| 108 | UAV control device |

1. A construction machine comprising:
a main body revolvable by revolving of a revolving member;
a first working device including a plurality of actuators and connected to the main body; and
a second working device including a plurality of actuators and connected to the main body.

2. The construction machine according to claim 1, further comprising:
a first rotary actuator that is different from the revolving member and moves the first working device in a rotation direction relative to the main body; and
a second rotary actuator that is different from the revolving member and moves the second working device in a rotation direction relative to the main body.

3. The construction machine according to claim 1, further comprising a moving device that moves a mass body in response to driving of the first working device or the second working device.

4. The construction machine according to claim 3, wherein the mass body moves in the main body to compensate for an unbalanced load acting on the main body in response to driving at least one of the first working device or the second working device.

5. The construction machine according to claim 3, wherein the mass body is a battery that supplies electric energy to at least a part of the construction machine.

6. The construction machine according to claim 1, further comprising a control device that causes the second working device to perform second work different from first work when the first working device is performing the first work.

7. The construction machine according to claim 1, further comprising a take-off and landing portion at which an unmanned flying object is capable of taking off and landing.

8. A construction machine system comprising:
a main body that travels by a traveling device;
a working device connected to the main body;
a take-off and landing portion provided on the main body where a drone is capable of taking off and landing, the drone including an image capturing device; and
a central control device that causes the drone to capture an image of the working device at different altitudes.

9. (canceled)

10. The construction machine system according to claim 8 9, wherein a part of a power supply unit that supplies power to the drone is provided in the take-off and landing portion.

11. (canceled)

12. (canceled)

13. (canceled)

14. (canceled)

15. (canceled)

16. The construction machine system according to claim 10, wherein a visual recognition mark is provided on the take-off and landing portion, and the part of the power supply unit is provided in the visual recognition mark.

17. The construction machine system according to claim 8, wherein the central control device causes to transmit an image data captured by the image capturing device to the central control device.

18. The construction machine system according to claim 8, wherein the central control device causes the drone to capture an image of a machine different from the working device.

19. The construction machine system according to claim 18, wherein the machine is a truck, and the central control device causes to stop the truck based on the image.

20. The construction machine system according to claim 8, wherein working device comprises a first working device connected to the main body and a second working device connected to the main body.

21. An assistance method for a construction machine, the method including:
driving a working device connected to a main body having an arm member and a distal end member connected to the arm member;
flying a drone closet to the distal end member while avoiding collision with the distal end member; and
imaging the distal end member by using drone and recognizing a condition of the distal end member during the driving.

22. The assistance method according to claim 21, wherein the drone takes off from a takeoff and landing portion on the main body and flies toward the distal end member.

23. The assistance method according to claim 22, wherein an image data of the distal end member captured by the drone is transmitted to a device different from the drone.

24. The assistance method according to claim 21, wherein the distal end member is one of a bucket, a breaker, a fork, or a ripper.
